(19) United States
(12) Patent Application Publication
(10) Pub. No.: US 2011/0096782 A1
(43) Pub. Date: Apr. 28, 2011

(54) METHOD FOR CONVERTING NETWORK ADDRESS

(75) Inventors: Jung Soo Park, Daejeon (KR); Hyoung Jun Kim, Daejeon (KR)

(73) Assignee: ELECTRONICS AND TELECOMMUNICATIONS RESEARCH INSTITUTE, Daejeon (KR)

(21) Appl. No.: 12/910,074

(22) Filed: Oct. 22, 2010

(30) Foreign Application Priority Data
Oct. 23, 2009 (KR) 10-2009-0101341

(51) Int. Cl. H04L 12/24

(52) U.S. Cl. 370/392

(57) ABSTRACT

In a network environment in which an endpoint identifier and a routing locator are separated from each other, a first router receives a data packet including an endpoint identifier of a first host and an endpoint identifier of a second host that is a communication target of the first host from the first host managed by the first router in order to convert a network address. A message requesting external address prefix information of the second host is transmitted to a second router managing the second host. In addition, the external address prefix information is received from the second router and a routing locator of the second host is generated by converting internal address prefix information of an endpoint identifier of the second host into the external address prefix information of the second host in the data packet.

### CROSS-REFERENCE TO RELATED APPLICATION

This application claims priority to and the benefit of Korean Patent Application No. 1 0-2009-01 01 341 filed in the Korean Intellectual Property Office on Oct. 23, 2009, the entire contents of which are incorporated herein by reference.

### BACKGROUND OF THE INVENTION

(a) Field of the Invention

The present invention relates to a method for converting a network address, and more particularly, to a method for converting a network address in an Internet environment where an endpoint identifier and a routing locator are separated from each other.

(b) Description of the Related Art

Recently, research into a fundamental structural problem of the Internet based on the Internet protocol version 4 (IPv4) has been in progress by organizations such as the Internet Engineering Task Force (IETF) and the Internet Research Task Force (IRTF). Herein, the structural problem includes routing scalability and mobility of a global Internet scale.

Herein, the Internet performs routing while identifying a node on a network by using an Internet protocol (IP) address. That is, the IP address has both a function of an endpoint identifier (hereinafter referred to as “EID”) for identifying the node and a function of a routing locator (referred to as “RLOC”) for informing of the location on the network. In order to solve the problem of routing scalability at the time of using the Internet, the EID and the RLOC are separated from each other so as to not be simultaneously used, such as in a locator/identifier separation protocol (LISP), an alternative logical topology (ALT), and a protocol transit mapping service (APT). Likewise, the techniques separating the EID and the RLOC from each other support efficient multi-homing and traffic engineering by reducing an increase tendency of a routing table of a backbone zone (default route free zone) due to allocation of nonintegrated addresses and multi-homing support. At this time, the EID is maintained while being associated only with devices in a predetermined website without being subordinated to a network provider, and the RLOC is an address allocated in accordance with a network topology and is managed by the network provider.

Meanwhile, a network address translation (NAT) is a device for converting an address on a communication network, which is used to convert a private IP address into a public IP address. In order to solve a security problem by providing independence of an address in the Internet protocol version 6 (IPv6) while maintaining the advantages of the NAT, the use of an IPv6-based NAT66 (IPv6-to-IPv6 NAT) technology is increasing, which assures transparence between endpoints while providing the address independence on the basis of the IPv6. In the NAT66, an external address and an internal address are mapped with each other one-to-one like a NAT that is generally known. That is, the NAT66 does not need to maintain port mapping information by not using a port mapping method but by using an address mapping method, and does not need to newly calculate a checksum value of a transport layer protocol. However, only mapping information between an internal address prefix and an external address prefix is maintained.

At the time of using the Internet, how the IPv4 and the IPv6 will be used by being applied to the EID and the RLOC that are used to support the routing scalability and the mobility is not described in detail.

Accordingly, a technology for applying the IPv6-based network address converting technique to an Internet structure combining the LISP and the ALT that is improved to support the routing scalability and the mobility by separating the EID and the RLOC from each other is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for converting a network address based on IPv6 for applying an IPv6-based network address converting technique to an Internet structure combining an LISP and an ALT that are improved to support routing scalability and mobility.

An exemplary embodiment of the present invention provides a method for converting a network address in a first router of a network environment where an end point identifier and a routing locator are separated from each other that includes:

receiving a data packet including an endpoint identifier of a first host and an endpoint identifier of a second host that is a communication target of the first host from the first host managed by the first router; transmitting a message requesting external address prefix information of the second host to a second router managing the second host; receiving the external address prefix information from the second router; and generating a routing locator of the second host by converting internal address prefix information of the endpoint identifier of the second host into the external address prefix information of the second host in the data packet.

Another embodiment of the present invention provides a method for converting a network address in a first router managing a first host in a network environment in which an endpoint identifier and a routing locator are separated from each other that includes:

receiving a message requesting an external address prefix of the first host from a second router managing a second host; transmitting an external address prefix of the first host to the second router; receiving a data packet transmitted from the second host from the second router; and transmitting the data packet to the first host, wherein the data packet received from the second host includes a routing locator of the first host generated by converting an internal address prefix of an endpoint identifier of the first host into the external address prefix of the first host.

### BRIEF DESCRIPTION OF THE DRAWINGS

FIG. 1 is a diagram schematically showing a structure of a network according to an embodiment of the present invention;

FIG. 2 is a diagram schematically showing an example of a data packet type including an EID or RLOC address used in an IPv6-based network according to an embodiment of the present invention;

FIG. 3 is a diagram schematically showing a communication procedure between hosts that do not move on a network according to an embodiment of the present invention;

FIG. 4 is a diagram schematically showing a communication procedure between hosts that move on a network according to an embodiment of the present invention;

FIG. 5 is a diagram schematically showing a mapping information updating procedure by movement of a counterpart host between hosts previously performing communication on a network according to an embodiment of the present invention;

FIG. 6 is a diagram schematically showing a prefix information acquiring procedure by movement of a counterpart host between hosts previously performing communication on a network according to an embodiment of the present invention; and

FIG. 7 is a diagram schematically showing a communication procedure by movement of a counterpart host between hosts previously performing communication on a network according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

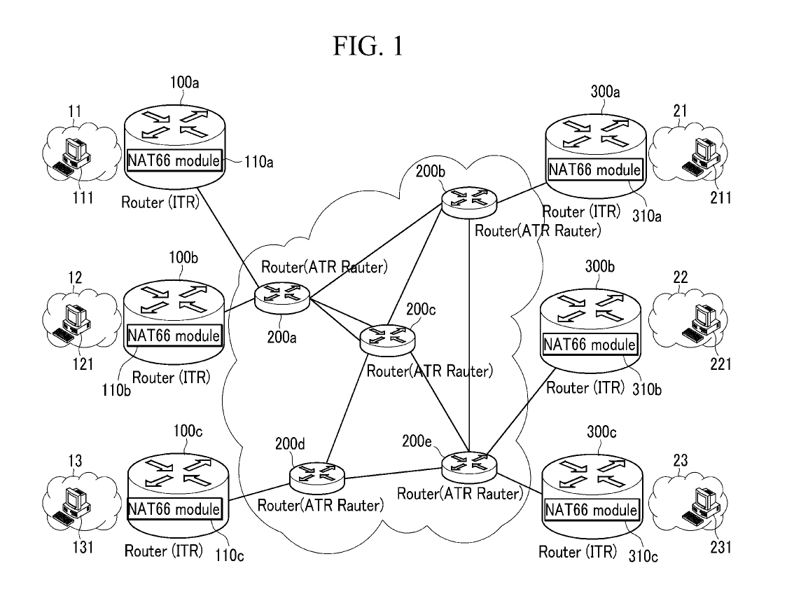

FIG. 1 is a diagram schematically showing a structure of a network according to an embodiment of the present invention.

As shown in FIG. 1, the network according to the embodiment of the present invention includes ingress tunnel routers (ITR) 100a to 100c, ALT routers 200a to 200e, and egress tunnel routers (ETR) 300a to 300c in order to apply an IPv6-based network address converting technique in an Internet environment combining a locator/identifier separation protocol (LISP) and an alternative logical topology (ALT).

Modules 110a to 110c having a function of the IPv6-based NAT66 (IPv6-to-IPv6 NAT) are mounted on each of the routers (ITR) 100a to 100c, and communication is performed by separating the endpoint identifier (hereinafter referred to as “EID”) and the routing locator (hereinafter referred to as “RLOC”) from each other in accordance with the function of each of the NAT66 modules 110a to 110c. That is, the routers (ITR) 100a to 100c maintain mapping of an internal address prefix and an external address prefix of each of hosts 111, 121, and 131 in networks 11 to 13 managed by the routers 100a to 100c. In addition, the routers (ITR) 100a to 100c maintain mapping of an internal address prefix and an external address prefix of hosts 211, 221, and 231 in networks 21 to 23 that are not managed by the routers 100a to 100c. Herein, the EID includes the internal address prefix acquired from the router and information of the corresponding host in a network as an IPv6 address block that is internally used in the network, and is transmitted by being included in a partial region of a packet. The EID is allocated once through a router at a first location and is uniquely maintained. The RLOC as an IPv6 address block that is externally used in the network includes an external address prefix and the corresponding router (ITR) information, and is transmitted by being included in the partial region of the packet.

The routers (ALT routers) 200a to 200e are hierarchically configured. The routers (ALT routers) 200a to 200c hierarchically integrate and maintain an external address prefix for routing in order to rapidly detect the address prefix mapping information maintained by the routers (ITR) 100a to 100c and the routers (ETR) 300a to 300c.

Modules 310a to 310c having a function of the IPv6-based NAT66 are mounted on the routers (ETR) 300a to 300c, and perform communication by separating the EID and the RLOC from each other in accordance with the function of each of the NAT66 modules 310a to 310c. That is, the routers

(ETR) 300a to 300c maintain mapping of an internal address prefix and an external address prefix of each of the hosts 211, 221, and 231 in the networks 21 to 23 managed by the routers (ETR) 300a to 300c in order to support the function of the NAT66 modules 310a to 310c. In addition, the routers (ETR) 300a to 300c maintain mapping of an internal address prefix and an external address prefix of the hosts 111, 121, and 131 in the networks 11 to 13 that are not managed by the routers (ETR) 300a to 300c.

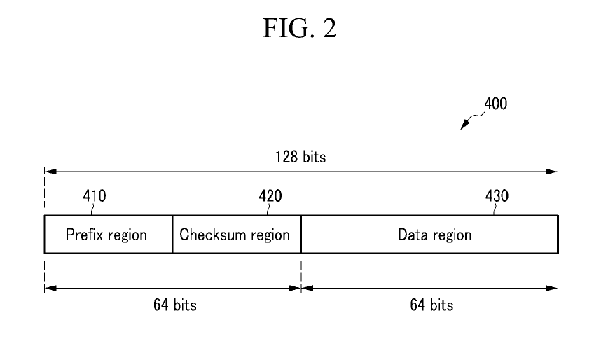

FIG. 2 is a diagram schematically showing an example of a data packet type including an EID or RLOC address used in an IPv6-based network according to an embodiment of the present invention.

Referring to FIG. 2, the IPv6 address 400 used in the IPv6-based network according to the embodiment of the present invention is formed by 128 bits, and 64 lower bits of the 128 bits maintain host information as a data region 430 as it is and 64 upper bits are divided into a prefix region 410 and a checksum region 420. At this time, the internal address prefix or the external address prefix is included in the prefix region 410. When the address is converted between an inner part and an outer part, the checksum region 420 includes a value that is compensated so as to not change a checksum value.

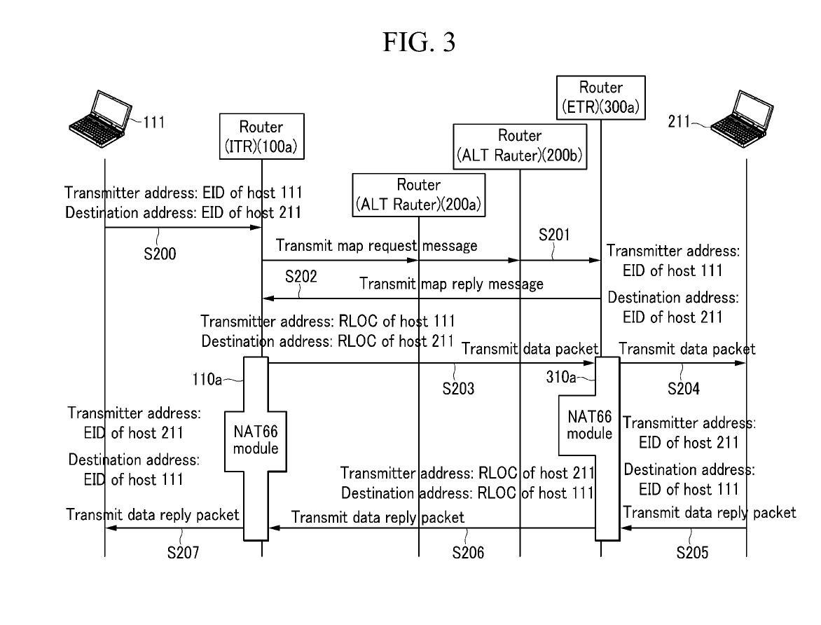

FIG. 3 is a diagram schematically showing a communication procedure between hosts that do not move on a network according to an embodiment of the present invention.

In FIG. 3, assuming that the host 111 managed by the router (ITR) 100a and the host 211 managed by the router (ETR) 300a according to the embodiment of the present invention do not move on the network, a communication procedure between the host 111 and the host 211 will be described.

Referring to FIGS. 1 and 3, the host 111 according to the embodiment of the present invention first transmits a data packet to the router (ITR) 100a in order to transmit the data packet to the host 211 (S200). At this time, the EID of the host 111 is a sending source address for sending the data packet and the EID of the host 211 is a destination address for receiving the data packet.

When the router (ITR) 100a does not have information on the RLOC corresponding to the EID of the host 211 which is the destination address, the router (ITR) 100a cannot know which router has the information on the RLOC of the host 211, such that the router (ITR) 100a transmits a map request message to the router (ALT router) 200a closest thereto. The map request message is transmitted up to the router (ALT router) 200b closest to the router (ETR) 300a through adjacent routers that are hierarchically maintained in the router (ALT router) 200a. The router (ALT router) 200b lastly transmits the map request message to the router (ETR) 300a (S201). At this time, content for requesting information on the external address prefix mapped with the internal address prefix for forming the RLOC of the host 211 is included in the map request message, and in addition, the EID of the host 211 is also included in the map request message for the router (ETR) 300a to find the information on the external address prefix of the host 211.

The router (ETR) 300a generates a map reply message including information on the external address prefix mapped with the internal address prefix of the host 211, and transmits the generated map reply message to the router (ITR) 100a (S202).

When the information on the external address prefix of the host 211 is received, the NAT66 module 110a of the router (ITR) 100a determines the RLOC of the host 211 by converting the information on the internal address prefix of the EID of the host 211 into the information on the external address prefix in accordance with an address mapping algorithm, and sets the RLOC as the destination address. In addition, the NAT66 module 110a of the router (ITR) 100a determines the RLOC of the host 111 by converting the already known information on the internal address prefix of the EID of the host 111 into the information on the external address prefix in accordance with the already known address mapping algorithm, and sets the RLOC as the sending source address. The NAT66 module 110a of the router (ITR) 100a first transmits the data packet to the NAT66 module 310a of the router (ETR) 300a on the basis of the RLOC of the host 211, which is the destination address (S203). Herein, the router (ITR) 100a holds the information on the external address prefix information for determining the RLOC of the host 211 for a predetermined time.

The NAT66 module 310a of the router (ETR) 300a determines the EID of the host 111 by converting the information on the external address prefix of the RLOC of the host 111 into the information on the internal address prefix in accordance with the address mapping algorithm, and sets the EID as the sending source address. The address mapping algorithm according to the embodiment of the present invention can be implemented as all mapping algorithms that maintain a one-to-one mapping rule. The NAT66 module 310a of the router (ETR) 300a determines the EID of the host 211 by converting the information on the external address prefix of the RLOC of the host 211 into the information on the internal address prefix in accordance with the address mapping algorithm, and sets the EID as the destination source address. The NAT66 module 310a of the router (ETR) 300a transmits the data packet to the host 211 in accordance with the internal address prefix included in the EID of the host 211 (S204). At this time, since the NAT66 module 310a of the router (ETR) 300a does not perform communication in a state where the NAT66 module 310a previously knows whether the host 211 is a mobile host or a fixed host, the NAT66 module 310a checks an environment regarding whether or not tunneling occurs before operating the function of the NAT66.

The host 211 transmits the data reply packet with respect to the data packet to the NAT66 module 310a of the router (ETR) 300a when there is a reply message with respect to the data packet (S205). At this time, the EID of the host 211 is the sending source address for sending the data reply packet and the EID of the host 111 is the destination address for receiving the data reply packet.

The NAT66 module 310a of the router (ETR) 300a determines the RLOC of the host 111 by converting the information on the internal address prefix of the EID of the host 111 into the information on the external address prefix in accordance with the address mapping algorithm, and sets the RLOC as the destination address. In addition, the NAT66 module 310a of the router (ETR) 300a determines the RLOC of the host 211 by converting the information on the internal address prefix of the EID of the host 211 into the information on the external address prefix in accordance with the address mapping algorithm, and sets the RLOC as the sending source address. The NAT66 module 310a of the router (ETR) 300a transmits the data reply packet to the NAT66 module 110a of the router (ITR) 100a on the basis of the RLOC of the host 111, which is the destination address (S206).

The NAT66 module 110a of the router (ITR) 100a determines the EID of the host 211 by converting the information on the external address prefix of the host 211 into the information on the internal address prefix in accordance with the address mapping algorithm, and sets the EID as the sending source address. In addition, the NAT66 module 110a of the router (ITR) 100a determines the EID of the host 111 by converting the information on the external address prefix of the RLOC of the host 111 into the information on the internal address prefix in accordance with the address mapping algorithm, and sets the EID as the destination address. The NAT66 module 110a of the router (ITR) 100a transmits the data reply packet to the host 111 on the basis of the EID of the host 111, which is the destination address (S207).

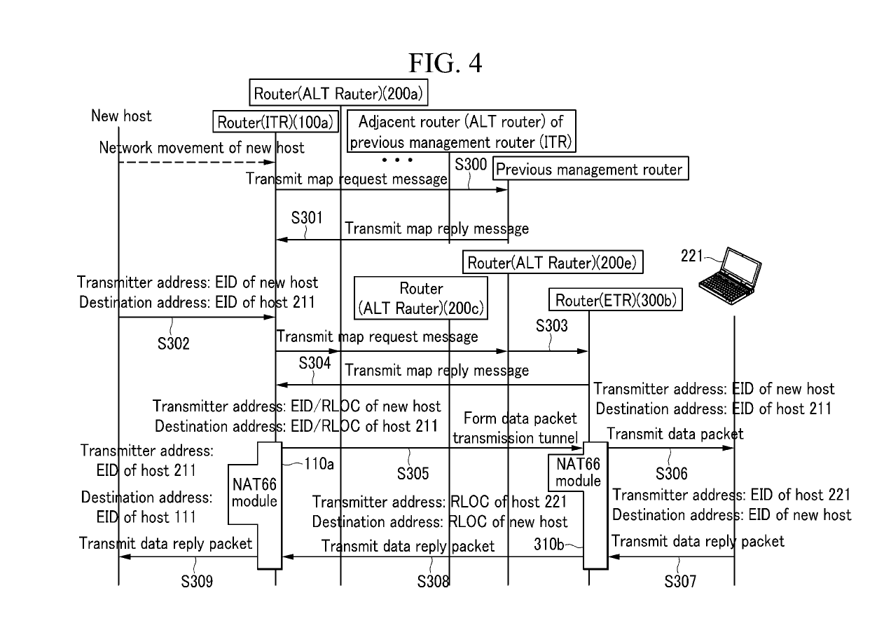

FIG. 4 is a diagram schematically showing a communication procedure between hosts that move on a network according to an embodiment of the present invention.

In FIG. 4, assuming that a new host (not shown) moves to the network managed by the router (ITR) 100a according to the embodiment of the present invention, a communication procedure between the host 221 and the new host will be described.

Referring to FIGS. 1 and 4, the router (ITR) 100a according to the embodiment of the present invention recognizes that the new host moves and comes and when an internal address prefix of the new host is not the internal address prefix managed by the router (ITR) 100a, the router (ITR) 100a transmits a map request message to the router (ALT) 200a closest thereto in order to transmit a map request message indicating that the new host moves and comes to the router (ITR) (not shown) (hereinafter, referred to as “previously managed router (ITR)”) that previously managed the new host. The router (ALT router) 200a transmits the map request message from the hierarchically maintained adjacent routers, and transmits the map request message to the previously managed router (ITR) through the hierarchically maintained routers (S300). Herein, the map request message indicates that the new host moves and comes to the router (ITR) 100a, and includes a domain directing a command to delete mapping information of the new host maintained in the previously managed router (ITR). Herein, the mapping information is the connection information between the internal address prefix information of the EID and the external address prefix information of the RLOC.

The previously managed router (ITR) determines a map reply message including information indicating that the mapping information of the new host is deleted, and transmits the determined map reply message to the router (ITR) 100a (S301). That is, the previously managed router (ITR) maintains updated information in which the mapping information of the new host is deleted.

After the new host moves on the network 10, the new host first transmits the data packet to the router (ITR) 100a in order to transmit the data packet to the host 221 managed by the router (ETR) 300b (S302). At this time, the EID of the new host is the sending source address for sending the data packet and the EID of the host 221 is the destination address for receiving the data packet.

The router (ITR) 100a recognizes that it does not have information on the RLOC corresponding to the EID of the host 221, which is the destination address. Since the router (ITR) 100a does not know which router has the information on the RLOC of the host 221, the router (ITR) 100a transmits the map request message to the router (ALT router) 200a closest thereto. That is, the map request message is transmitted up to the router (ALT router) 200e closest to the router (ETR) 300b through adjacent routers that are hierarchically maintained in the router (ALT router) 200a. The router (ALT router) 200b lastly transmits the map request message to the router (ETR) 300b (S303). At this time, content for requesting information on the external address prefix mapped with the internal address prefix for forming the RLOC of the host 221 is included in the map request message, and in addition, the EID of the host 221 is also included in the map request message for the router (ETR) 300b to find the information on the external address prefix of the host 221.

The router (ETR) 300b generates a map reply message including information on the external address prefix mapped with the internal address prefix for forming the RLOC of the host 221, and transmits the generated map reply message to the router (ITR) 100a (S304).

Since the router (ITR) 100a does not manage the internal address prefix of the new host, the NAT66 module 110a does not operate. That is, the internal address prefix information of the EID of the new host is allocated to the router where the new host is first positioned and the router (ITR) 100a does not thus manage the internal address prefix information, such that the router (ITR) 100a does not operate the NAT66 module 110a. Therefore, a tunnel is formed between the router (ITR) 100a and the router (ETR) 30b in order to perform a function generated in accordance with an Internet structure of the general LISP and ALT, and the data packet is transmitted through the tunnel (S305). Herein, only the external address prefix for forming the RLOC of the new host is acquired through the tunnel formed between the router (ITR) 100a and the router (ETR) 300b. At this time, in a tunneling method through the tunnel, the RLOC of the new host acquired through the tunneling is encapsulated and transmitted by being, as it is, included in the EID of the new host without using the address mapping algorithm.

The NAT66 module 310b of the router (ETR) 300b decapsulates only a packet included in the data packet transmitted through the tunnel, and transmits the decapsulated packet to the host 221 set as the destination address (S306). At this time, the EID of the new host is the sending source address for sending the data packet and the EID of the host 221 is the destination address for receiving the data packet.

The host 221 transmits the reply packet with respect to the data packet to the NAT66 module 310b of the router (ETR) 300b when there is a reply message with respect to the data packet (S307). At this time, the EID of the host 221 is the sending source address for sending the data reply packet and the EID of the new host is the destination address for receiving the data reply packet.

The NAT66 module 310b of the router (ETR) 300b determines the RLOC of the new host by converting the information on the internal address prefix of the EID of the new host into the information on the external address prefix in accordance with the address mapping algorithm, and sets the RLOC as the destination address. In addition, the NAT66 module 310b of the router (ETR) 300b determines the RLOC of the host 221 by converting the information on the internal address prefix of the EID of the host 221 into the information on the external address prefix in accordance with the address mapping algorithm, and sets the RLOC as the sending source address. The NAT66 module 310b of the router (ETR) 300b transmits the data reply packet to the NAT66 module 110a of the router (ITR) 100a on the basis of the RLOC of the new host, which is the destination address (S308).

The NAT66 module 110a of the router (ITR) 100a verifies whether or not tunneling with the new host occurs, and when the tunneling does not occur, determines the EID of the host 221 by converting the information on the external address prefix of the RLOC of the host 221 into the information on the internal address prefix in accordance with the address mapping algorithm to set the EID as the sending source address. In addition, the NAT66 module 110a of the router (ITR) 100a determines the EID of the host 111 by converting the information on the external address prefix of the RLOC of the new host into the information on the internal address prefix in accordance with the address mapping algorithm to set the EID as the destination address. The NAT66module 110a of the router (ITR) 100a transmits the data reply packet to the new host on the basis of the EID of the new host, which is the destination address (S309).

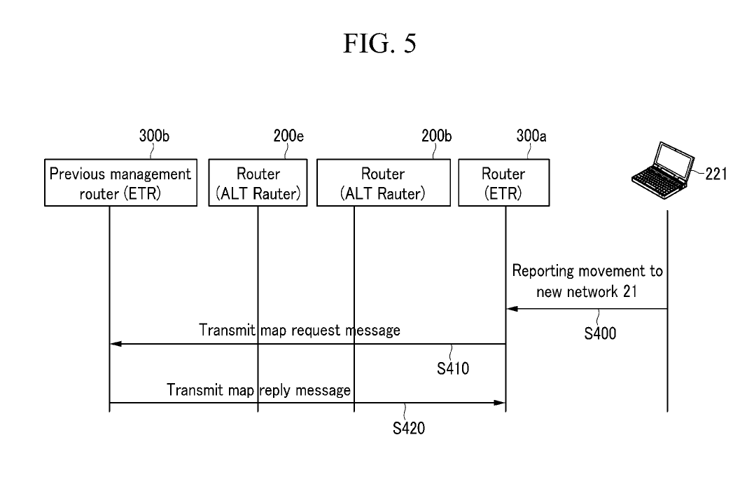

Next, a communication procedure when a counterpart host moves in a state where a communication procedure is performed once in advance will be described in detail with reference to FIGS. 5 to 7.

FIG. 5 is a diagram schematically showing a mapping information updating procedure by movement of a counterpart host between hosts previously performing communication on a network according to an embodiment of the present invention.

In FIG. 5, it is assumed that after the host 221 of the router (ETR) 300b that manages the network 22 on the network according to the embodiment of the present invention performs communication with the host 111 of the router (ITR) 100a that manages the network 11 in advance, the host 221 moves to the network 21 at the time when the host 111 attempts communication with the host 221 again.

Referring to FIGS. 1 and 5, since the host 221 according to the embodiment of the present invention moves to the network 21 managed by the router (ETR) 300a, the host 221 notifies a previously managed router (ETR) 300a (hereinafter, referred to as “previously managed router (ETR) 300a) that it moves to the network 21 (S400).

The router (ETR) 300a recognizes that the host 221 moves and comes, and transmits the map request message to the router (ALT router) 200b closest thereto in order to transmit the map request message to the previously managed router (ETR) 300b of the host 221. The router (ALT router) 200b transmits the map request message from the hierarchically maintained adjacent routers, and transmits the map request message to the previously managed router (ETR) 300b through the hierarchically maintained routers (S410). Herein, the map request message indicates that the host 221 moves and comes to the router (ETR) 300a, and includes a domain directing a command to delete mapping information of the host 221 maintained in the previously managed router (ETR) 300b.

The previously managed router (ETR) 300b generates a map reply including information indicating that the mapping information of the host 221 is deleted, and transmits the generated map reply message to the router (ETR) 300a (S420). That is, since the host 221 moves from the network 22 to the network 21, the previously managed router (ETR) 300b newly updates and stores the mapping information with movement of the host 221. Herein, the mapping information includes external address prefix information with respect to the host 221 that moves to the network 21.

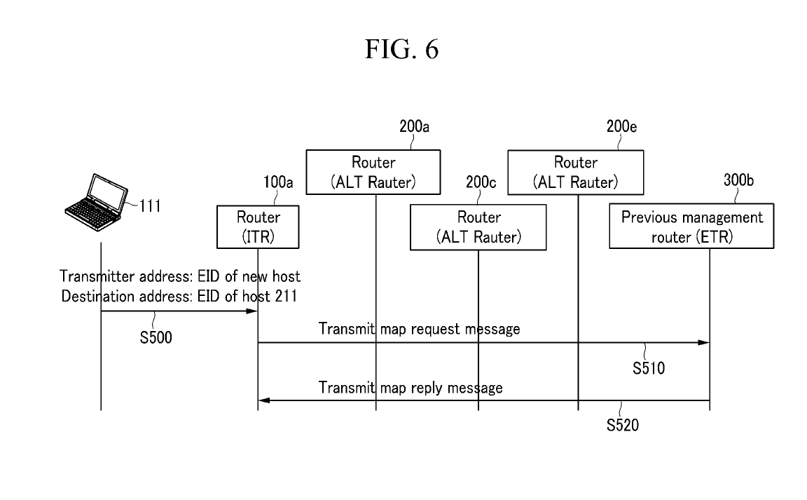

FIG. 6 is a diagram schematically showing a prefix information acquiring procedure by movement of a counterpart host between hosts previously performing communication on a network according to an embodiment of the present invention.

In FIG. 6, it is assumed that the host 221 according to the embodiment of the present invention moves to the network 21 managed by the router (ETR) 300a from the network 22 managed by the router (ETR) 300b, and thereafter the host 221 receives the data packet from the host 111.

Referring to FIGS. 1 and 6, the host 111 according to the embodiment of the present invention transmits the data packet to the router (ITR) 100a in order to transmit the data packet to the host 221 (S500). At this time, the EID of the host 111 is the sending source address for sending the data packet and the EID of the host 221 is the destination address for receiving the data packet.

Since the router (ITR) 100a still does not know that the host 221 moves from the network 22 to the network 21, the router (ITR) 100a transmits the map request message to the router (ALT router) 200a closest thereto in order to transmit the map request message to the previously managed router (ETR) 300b of the host 221. That is, the map request message is transmitted up to the router (ALT router) 200e closest to the router (ETR) 300b through adjacent routers that are hierarchically maintained in the router (ALT router) 200a. The router (ALT router) 200b lastly transmits the map request message to the router (ETR) 300b (S510). At this time, content for requesting information on the external address prefix mapped with the internal address prefix for forming the RLOC of the host 221 is included in the map request message, and in addition, the EID of the host 221 is also included in the map request message for the router (ETR) 300b to find the information on the external address prefix of the host 221.

The router (ETR) 300b generates a map reply message including information on the external address prefix with respect to the host 221 that moves to the network 21 managed by the router (ETR) 300a and transmits the map reply message to the router (ITR) 100a because the host 221 moves from the network 22 to the network 21, such that the mapping information of the host 221 is updated in accordance with the procedure shown in FIG. 5 (S520).

If the external address prefix information with respect to the sending source address of the host 111 that transmits the data packet is the same as that of the destination address of the host 221 while the host 221 moves to the network 11 managed by the router (ITR) 100a, the data packet is directly transmitted to the internal host 221 without determining the RLOC.

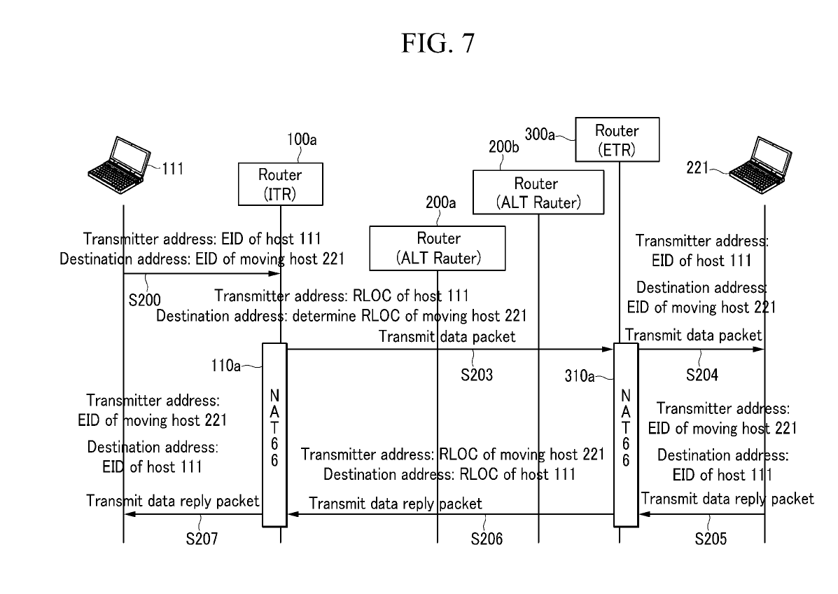

FIG. 7 is a diagram schematically showing a communication procedure by movement of a counterpart host between hosts previously performing communication on a network according to an embodiment of the present invention.

In FIG. 7, it is assumed that the host 221 and the host 111 performed the communication on the network according to the embodiment of the present invention in advance and the host 221 moves from the network 22 managed by the router (ETR) 300b to the network 21 managed by the router (ETR) 300a, and thereafter the host 221 performs the communication with the host 111 again.

Referring to FIGS. 1 and 7, the host 111 according to the embodiment of the present invention first transmits the data packet to the router (ITR) 100a in order to transmit the data packet to the host 221 (hereinafter referred to as “mobile host 221”) that moves between networks (S600). At this time, the EID of the host 111 is the sending source address for sending the data packet and the EID of the host 221 is the destination address for receiving the data packet.

Since the NAT66 module 110a of the router (ITR) 100a already has the information on the RLOC corresponding to the EID of the mobile host 221 that is the destination address in accordance with the procedure of FIG. 6, the NAT66 module 110a determines the RLOC of the mobile host 221 by converting the information on the internal address prefix of the mobile host 221 into the information on the external address prefix in accordance with the address mapping algorithm, and sets the RLOC as the destination address. In addition, the NAT66 module 110a of the router (ITR) 100a determines the RLOC of the host 111 by converting the information on the internal address prefix of the EID of the host 111 into the information on the external address prefix in accordance with the already known address mapping algorithm, and sets the RLOC as the sending source address. The NAT66 module 110a of the router (ITR) 100a first transmits the data packet to the NAT66 module 310a of the router (ETR) 300a on the basis of the RLOC of the mobile host 221, which is the destination address (S610).

The NAT66 module 310a of the router (ETR) 300a determines the EID by converting the information on the external address prefix of the RLOC of the host 111 into the information on the internal address prefix in accordance with the address mapping algorithm, and sets the EID as the sending source address. In addition, the NAT66 module 310a of the router (ETR) 300a determines the EID of the host 221 by converting the information on the external address prefix of the RLOC of the host 221 into the information on the internal address prefix in accordance with the address mapping algorithm, and sets the EID as the destination address. The NAT66 module 310a of the router (ITR) 300a transmits the data packet to the host 221 on the basis of the EID of the host 221, which is the destination address (S620).

The host 221 transmits the data reply packet with respect to the data packet to the NAT66 module 310a of the router (ETR) 300a when there is a reply message with respect to the data packet (S630). At this time, the EID of the host 221 is the sending source address for sending the data reply packet and the EID of the host 111 is the destination address for receiving the data reply packet.

The NAT66 module 310a of the router (ETR) 300a determines the RLOC of the host 111 by converting the information on the internal address prefix of the EID of the host 111 into the information on the external address prefix in accordance with the address mapping algorithm, and sets the RLOC as the destination address. In addition, the NAT66 module 310a of the router (ETR) 300a determines the RLOC of the host 221 by converting the information on the internal address prefix of the EID of the host 211 into the information on the external address prefix in accordance with the address mapping algorithm, and sets the EID as the sending source address. The NAT66 module 310a of the router (ETR) 300a transmits the data reply packet to the NAT66 module 110a of the router (ITR) 100a on the basis of the RLOC of the host 111, which is the destination address (S640).

The NAT66 module 110a of the router (ITR) 100a determines the EID of the host 221 by converting the information on the external address prefix of the RLOC of the host 221 into the information on the internal address prefix in accordance with the address mapping algorithm, and sets the EID as the sending source address. In addition, the NAT66 module 110a of the router (ITR) 100a determines the EID of the host 111 by converting the information on the external address prefix of the RLOC of the host 111 into the information on the internal address prefix in accordance with the address mapping algorithm, and sets the EID as the destination address. The NAT66 module 110a of the router (ITR) 100a transmits the data reply packet to the host 111 on the basis of the EID of the host 111, which is the destination address (S650).

As described above, according to an embodiment of the present invention, as communication is performed by applying an IPv6-based network address converting technique that maintains a mapping relationship between internal and external address prefixes of EID and RLOC in the network 10, which is improved to support routing scalability and mobility, tunneling is not used between hosts in a case where hosts do not move, thereby reducing a load in the network. In addition, as only an address prefix is maintained by a NAT66 module on each of routers (ITR) 100a to 100c and routers (ETR) 300a to 300c for applying an IPv6-based network address converting technique, data communication can be performed without maintaining mapping information of all the addresses.

In addition, according to an embodiment of the present invention, since tunneling for communication is not used by applying an IPv6-based network address converting technique to an Internet structure combining an LISP and an ALT that are improved to support routing scalability, it is possible to reduce a load on a network. In addition, according to an embodiment of the present invention, only an IPv6 address prefix is maintained by mounting a function of a NAT66 on an ingress tunnel router (ITR) and an egress tunnel router (ETR) associated with the IPv6-based network address converting technique, such that it is possible to prevent a problem in mapping information of all host addresses.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for converting a network address in a first router of a network environment where an end point identifier and a routing locator are separated from each other, comprising:
receiving a data packet including an endpoint identifier of a first host and an endpoint identifier of a second host that is a communication target of the first host from the first host managed by the first router;
transmitting a message requesting external address prefix information of the second host to a second router managing the second host;
receiving the external address prefix information from the second router; and
generating a routing locator of the second host by converting internal address prefix information of the endpoint identifier of the second host into the external address prefix information of the second host in the data packet.

2. The method of claim 1, wherein
the message includes the endpoint identifier of the second host.

3. Them method of claim 1, wherein
the internal address prefix information is converted into the external address prefix information in accordance with an address mapping algorithm.

4. The method of claim 1, wherein
the generating includes
generating a routing locator of the first host by converting internal address prefix information of the endpoint identifier of the first host into external address prefix information of the first host in the data packet.

5. The method of claim 4, wherein
the first router stores mapping information of the internal address prefix information of the endpoint identifier of the first host and the external address prefix information of the first host.

6. The method of claim 5, wherein
the data packet transmitted to the second router includes the routing locator of the first host and the routing locator of the second host.

7. The method of claim 1, further comprising
transmitting the data packet to the second router in accordance with the routing locator of the second host.

8. The method of claim 1, further comprising:
receiving a reply packet corresponding to the data packet from the second host; and
generating the endpoint identifier of the first host by converting external address prefix information of the routing locator of the first host into internal prefix information of the first host in the reply packet.

9. The method of claim 1, comprising,
when a third host moves to a network managed by the first router:
transmitting a message requesting deletion of mapping information of the third host held in a previous management router of the third host to the previous management router; and
receiving a reply message indicating that the mapping information is deleted from the previous management router.

10. The method of claim 9, wherein
the mapping information includes mapping information between internal address prefix information of an endpoint identifier of the third host and external address prefix information of the third host.

11. The method of claim 9, further comprising,
when the third host first communicates with the second host after receiving the reply message,
transmitting a data packet from the third host by forming a tunnel with the second router.

12. The method of claim 11, wherein
the data packet from the third host includes an endpoint identifier of the third host, a routing locator of the third host, the endpoint identifier of the second host, and the routing locator of the second host.

13. A method for converting a network address in a first router managing a first host in a network environment in which an endpoint identifier and a routing locator are separated from each other, comprising:
receiving a message requesting an external address prefix of the first host from a second router managing a second host;
transmitting the external address prefix of the first host to the second router;
receiving a data packet transmitted from the second host from the second router; and
transmitting the data packet to the first host,
wherein the data packet received from the second host includes a routing locator of the first host generated by converting an internal address prefix of an endpoint identifier of the first host into the external address prefix of the first host.

14. The method of claim 13, wherein
the data packet transmitted from the second host further includes a routing locator of the second host.

15. The method of claim 13, wherein
the data packet received from the second host is generated by converting the internal address prefix of the endpoint identifier of the first host into the external address prefix of the first host in accordance with an address mapping algorithm.

16. The method of claim 13, wherein
the message includes the endpoint identifier of the first host.

17. The method of claim 13, wherein
the first router includes mapping information of the internal address prefix of the endpoint identifier of the first host and the external address prefix of the first host.

18. The method of claim 13, further comprising:
receiving a reply packet corresponding to the data packet from the first host; and
generating a routing locator of the second host by converting an internal address prefix of an endpoint identifier of the second host into a external prefix of the second host in the reply packet.

19. The method of claim 18, further comprising
transmitting the reply packet to the second router in accordance with the routing locator of the second host.
